(19) United States
(12) Patent Application Publication
(10) Pub. No.: US 2013/0167219 A1
(43) Pub. Date: Jun. 27, 2013

(54) APPARATUS AND METHOD FOR CYBER-ATTACK PREVENTION

(71) Applicants: Woo-Sug JUNG, Daejeon-si (KR); Jong-Dae PARK, Daejeon-si (KR); Byung-Ho YAE, Daejeon-si (KR); Tae-Soo CHUNG, Daejeon-si (KR); Sung-Kee NOH, Daejeon-si (KR); Sung-Jin MOON, Daejeon-si (KR); Nam-Seok KO, Daejeon-si (KR); Hwan-Jo HEO, Daejeon-si (KR)

(72) Inventors: Woo-Sug JUNG, Daejeon-si (KR); Jong-Dae PARK, Daejeon-si (KR); Byung-Ho YAE, Daejeon-si (KR); Tae-Soo CHUNG, Daejeon-si (KR); Sung-Kee NOH, Daejeon-si (KR); Sung-Jin MOON, Daejeon-si (KR); Nam-Seok KO, Daejeon-si (KR); Hwan-Jo HEO, Daejeon-si (KR)

(73) Assignee: Electronics and Telecommunications Research Institute, Daejeon-si (KR)

(21) Appl. No.: 13/616,670

(22) Filed: Sep. 14, 2012

(30) Foreign Application Priority Data
Dec. 22, 2011 (KR) 10-2011-0140316

(51) Int. Cl. G06F 21/20

(52) U.S. Cl. 726/13

(57) ABSTRACT

Provided are a method of preventing cyber-attack based on a terminal and a terminal apparatus therefor. The terminal apparatus includes: a packet processor configured to determine whether excessive traffic is generated by a transmission packet; an anomalous traffic detecting unit configured to determine whether anomalous traffic is generated, using a first condition of the excessive traffic being maintained for a first time period and a second condition of a generation count of the same kind of transmission packets exceeding a predetermined threshold value for a second time period; and a traffic block request unit configured to generate a traffic block request signal for requesting blockage of the transmission packet according to the result of determining whether anomalous traffic is generated.

### CROSS-REFERENCE TO RELATED APPLICATION

This application claims the benefit under 35 U.S.C. §119(a) of Korean Patent Application No. 10-2011-0140316, filed on Dec. 22, 2011, the entire disclosure of which is incorporated herein by reference for all purposes.

### BACKGROUND

1. Field

The following description relates to technology for preventing cyber-attack using malicious code, and more particularly, to technology for effectively preventing cyber-attack using malicious code such as BotNet by preventing excessive traffic from entering a network.

2. Description of the Related Art

DDos attacks disable a network by infecting many computers on the network with malicious codes called Bots that turn them into “zombie PCs” so that the zombie PCs access a specific site simultaneously through communication with a C&C (Command & Control) server. A collection of two or more zombie PCs connected through a network is called a Botnet. Recently, 5000 or more new malicious codes are appearing every day since a Botnet named EggDrop appeared in 1993. In order to block cyber-attack using such a Botnet, a security monitoring system has been provided on a network.

However, a conventional security monitoring system deteriorates Quality of Service (QoS) due to its passive reactive process of looking for known malicious code signatures or new types of cyber-attack patterns to detect attack based on pattern matching and perform control. Also, a collaborative DDos defense system integrated with network equipment can block attack traffic individually by reducing a link transmission rate in cooperation with a security monitoring system, however, a concentrated attack on centralized network equipment can disable the equipment. That is, the conventional security monitoring system is vulnerable to cyber-attack due to new malicious codes or to cyber-terror concentrated on a server. Malicious codes cause social confusion as well as serious economic loss over time since they have the ability to self-replicate and infect other systems in a short time. Also, a centralized monitoring system is vulnerable to cyber-attack such as C&C that causes excessive traffic momentarily.

### SUMMARY

The following description relates to an apparatus and method for effectively preventing cyber-attack using malicious code such as Botnet by preventing excessive traffic from entering a network through analysis of a user's behavior patterns based on a terminal.

In one general aspect, there is provided a terminal apparatus including: a packet is processor configured to determine whether excessive traffic is generated by a transmission packet; an anomalous traffic detecting unit configured to determine whether anomalous traffic is generated, using a first condition of the excessive traffic being maintained for a first time period and a second condition of a generation count of the same kind of transmission packets exceeding a predetermined threshold value for a second time period; and a traffic block request unit configured to generate a traffic block request signal for requesting blockage of the transmission packet according to the result of determining whether anomalous traffic is generated.

When at least one of the first and second conditions is satisfied, the anomalous traffic detecting unit may generate an anomalous traffic detection signal indicating that anomalous traffic has been generated.

The terminal apparatus may further include a user matching unit configured to determine whether to block traffic based on a user input signal, wherein the packet processor blocks transmission of the transmission packet when a block approval response signal for approving traffic blocking is received from the user matching unit based on the user input signal.

The user matching unit may process a transmission packet that generated the anomalous traffic, and provide a user interface screen for providing detailed information about the transmission packet.

The terminal apparatus may further include an interrupt analyzer configured to count a number of first interrupts generated by transmission packets for a predetermined interrupt count period, and a number of second interrupts generated by a user's inputs for the predetermined interrupt count period, thereby generating an interrupt count value, wherein the anomalous traffic detecting unit controls the interrupt analyzer to operate when both the first and second conditions are satisfied.

The interrupt analyzer may add the number of the first interrupts to the number of the is second interrupts, and generate the result of the addition as the interrupt count value.

The anomalous traffic detecting unit may receive the interrupt count value, and generate, when the interrupt count value is equal to or greater than a reference interrupt count value, an anomalous traffic detection signal indicating that anomalous traffic has been generated.

When the predetermined interrupt count period elapses, the interrupt analyzer may initialize the interrupt count value, and generate an interrupt count value for the next interrupt count period.

The packet processor may receive the traffic block request signal, and transmit a transmission packet related to the traffic block request signal to a security monitoring center connected through a network in order to determine whether the transmission packet includes an attack pattern.

When it receives the traffic block request signal in a normal security mode, the packet processor may block transmission of the transmission packet after receiving approval from a user, and when it receives the traffic block request signal in a high security mode requiring a higher level of security than the normal security mode, the packet processor may block transmission of the transmission packet without having to receive approval from the user.

The packet processor may include: a packet counter configured to count a number of transmission packets in a predetermined packet count period; a packet count period setting unit configured to create the predetermined packet count period; a packet buffer configured to buffer transmission packets, and transmit a transmission packet which is expected to include an attack pattern to a security monitoring system; and an excessive traffic detector configured to generate an excessive traffic detection signal when the counted number of transmission packets exceeds a predetermined threshold value.

The packet count period setting unit may generate a packet count initializing signal in units of the predetermined packet count period, and initialize the counted number of transmission packets when the packet count initializing signal is received.

The anomalous traffic detecting unit may include: an excessive traffic determiner configured to determine whether the excessive traffic is maintained for the first time period; and an anomalous packet detector configured to determine whether the generation count of the same kind of transmission packets exceeds the predetermined threshold value for the second time period.

In another general aspect, there is provided a method of preventing cyber-attack in a terminal apparatus, including: determining whether excessive traffic is generated by a transmission packet; determining whether anomalous traffic is generated using a first condition of the excessive traffic being maintained for a first time period and a second condition of a generation count of the same kind of transmission packets exceeding a predetermined threshold value for a second time period; and generating a traffic block request signal for requesting blockage of the transmission packet according to the result of determining whether anomalous traffic is generated.

Other features and aspects will be apparent from the following detailed description, the drawings, and the claims.

### BRIEF DESCRIPTION OF THE DRAWINGS

FIG. 1 is a diagram illustrating an example of a terminal apparatus for preventing cyber-attack.

FIG. 2 is a diagram illustrating an example of a packet processor of FIG. 1.

FIG. 3 is a diagram illustrating an example of an interrupt analyzer of FIG. 1.

FIG. 4 is a diagram illustrating an example of an anomalous traffic detecting unit of FIG. 1.

FIG. 5 is a flowchart illustrating an example of a method of preventing cyber-attack based on a terminal.

FIG. 6 is a flowchart illustrating another example of a method of preventing cyber-attack based on a terminal.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

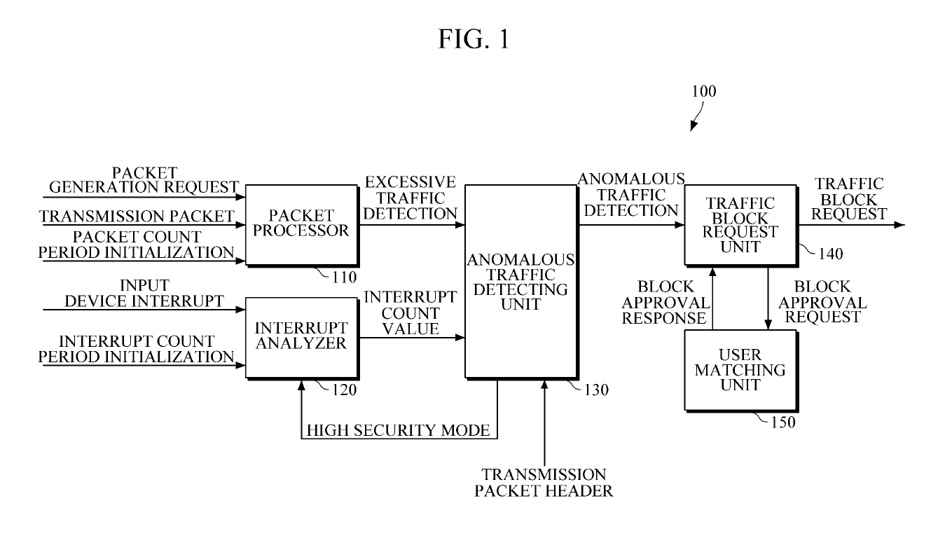

FIG. 1 is a diagram illustrating an example of a terminal apparatus 100 for preventing cyber-attack.

The terminal apparatus 100 is configured to prevent excessive traffic from entering a network through traffic analysis based on a terminal, thereby reducing a load applied to a conventional centralized security monitoring system to prevent cyber-attack. Also, the terminal apparatus 100 has a distributed monitoring structure through analysis of a user's behavior based on a terminal.

In detail, the terminal apparatus 100 monitors an amount of traffic generated in the corresponding terminal, analyzes a user's behavior pattern to determine whether the user generates an excessive amount of data exceeding that generated by normal operation, and detects an abnormal state in which anomalous traffic has been generated, if it is determined that the user has generated an excessive amount of data. When detecting anomalous traffic, the terminal apparatus 100 may adjust the amount of traffic generated in the terminal according to a request from the user.

The terminal apparatus 100 is configured to perform a cyber-attack prevention method including a method of determining whether excessive traffic has been generated in the terminal apparatus 100, and a method of determining, when excessive traffic has been generated, whether the traffic has been generated by the user or by malicious code such as Botnet.

Referring to FIG. 1, the terminal apparatus 100 includes a packet processor 110, an interrupt analyzer 120, an anomalous traffic detecting unit 130, a traffic block request unit 140, and a user matching unit 150. Also, the terminal apparatus 100 may further include other components having various functions, such as a user input unit, a display, a data processor, etc. The following description, for convenience, relates to components for detecting and blocking anomalous traffic.

The packet processor 110 processes transmission packets that are to be transmitted through the terminal apparatus 100. The packet processor 110 may communicate with a security monitoring center connected through a network, and output the transmission packets to the network. The packet processor 110 may create a transmission packet according to a packet generation request from a processor (not shown).

The packet processor 110 may determine, before transmitting the transmission packet to is the network, whether excessive traffic is generated by the transmission packet. At this time, the packet processor 110 may receive a packet count initializing signal from the processor, set a packet count period according to the packet count initializing signal, and count the number of transmission packets for the packet count period. However, it is also possible that transmission packets are created and processed by an external module (not shown), instead of the packet processor 110, and the packet processor 110 is configured only to determine whether excessive traffic is generated by each transmission packet.

The interrupt analyzer 120 performs a function of counting the number of interrupts generated in the terminal apparatus 100 and determining whether the generated excessive traffic was caused by the user. The interrupt analyzer 120 may operate when it receives a high security mode signal from the anomalous traffic detecting unit 130, in the event that excessive traffic is detected by the packet processor 110 and anomalous traffic is detected by the anomalous traffic detecting unit 130. As such, only in specific situations such as when anomalous traffic is detected, by causing the interrupt analyzer 120 to monitor the frequency of interrupt occurrences, is it possible to minimize deterioration in performance of the terminal apparatus 100.

The interrupt analyzer 10 counts the number of first interrupts generated by transmission packets and the number of second interrupts generated by a user's inputs, for a predetermined interrupt count period, thereby generating an interrupt count value. The interrupt analyzer 120 may receive an interrupt count initializing signal from a processor (not shown) in order to set a predetermined interrupt count period. Also, the interrupt analyzer 120 receives an interrupt that is generated whenever a transmission packet is received from the packet processor 110 to count the number of first interrupts, and receives an input device interrupt that is generated according to a user's input to count the number of second interrupts.

The interrupt analyzer 120 adds the number of the first interrupts to the number of the second interrupts, and generates the result of the addition as the interrupt count value. The interrupt analyzer 120 may transfer the interrupt count value to the anomalous traffic detecting unit 130. If the interrupt count value is equal to or greater than a reference interrupt count value, the anomalous traffic detecting unit 130 may generate an anomalous traffic detection signal indicating that anomalous traffic has been generated.

If excessive traffic continues to be generated in the terminal apparatus 100, or if the generation count of the same kind of transmission packets exceeds a threshold value, the anomalous traffic detecting unit 130 generates an anomalous traffic detection signal in order to prevent excessive traffic generated in the terminal apparatus 100 from influencing the network.

Also, if it receives an excessive traffic detection signal indicating that excessive traffic is detected from the packet processor 110 for a first time period or more, and simultaneously detects anomalous traffic to generate an anomalous traffic detection signal, the anomalous traffic detecting unit 130 may create a high security mode signal for driving the interrupt analyzer 120.

For creating the high security mode signal, the anomalous traffic detecting unit 130 may monitor the excessive traffic detection signal for the first time period to determine whether the excessive traffic generated in the terminal is momentary or continuous traffic. Also, the anomalous traffic detecting unit 130 compares transmission packet headers in units of a predetermined time to determine whether the generation count of the same kind of transmission packets exceeds a threshold value for a second time period, and determines, if the generation count of the same kind of transmission packets exceeds the threshold value for the second time period, that the corresponding traffic has been generated by malicious code such as Botnet, not by the user, thereby generating an anomalous traffic detection signal.

Here, the first and second time periods are criteria for detecting anomalous traffic, and is may be set to the same or different time periods. After generating the anomalous traffic detection signal, the anomalous traffic detecting unit 130 may perform an operation of preventing the excessive traffic generated in the terminal apparatus 100 from entering the network in order to avoid an excessive burden on the network.

If it is assumed that the case where excessive traffic is maintained for the first time period is a first condition, and the case where the generation count of the same kind of transmission packets exceeds the threshold value for the second time period is a second condition, the anomalous traffic detection unit 130 detects anomalous traffic according to whether at least one of the first and second conditions is satisfied, thereby generating an anomalous traffic detection signal.

The anomalous traffic detecting unit 130 may transfer the anomalous traffic detection signal to the traffic block request unit 140. The traffic block request unit 140 may receive the anomalous traffic detection signal and generate a traffic block request signal. Also, the traffic block request unit 140 may transfer a block approval request signal for asking for the user's approval to block the corresponding packet, to the user matching unit 150.

The user matching unit 150 is connected to a user input/output unit (not shown) to receive and process user input signals, and to determine whether to block traffic with respect to transmission packets based on the user input signals.

In order to provide information about transmission packets that have generated anomalous traffic, the user matching unit 150 may process transmission packets that have generated anomalous traffic, create a user interface screen that provides detailed information about the transmission packets, and provide the user interface screen through a user input/output unit (not shown), such as a touch screen, a keyboard, a monitor, etc. A user input signal for deciding whether to block the corresponding traffic is input to the user matching unit 159 is through the user input/output unit. If the user input signal indicates that the corresponding traffic has to be blocked, the user matching unit 150 may generate a block approval response signal and transfer the block approval response signal to the traffic block request unit 140. If it receives the block approval response signal from the user matching unit 150, the traffic block request unit 140 generates a traffic block request signal for blocking transmission of the packet, thereby causing excessive traffic from the terminal apparatus 100 to no longer enter the network.

If a transmission packet that generated anomalous traffic is buffered in the packet processor 110, a traffic block request signal may be transferred to the packet processor 110. Also, the traffic block request unit 140 may transfer a security monitoring request signal, together with the traffic block request signal, to the packet processor 110. When it receives the security monitoring request signal, the packet processor 110 may transmit the corresponding transmission packet as a security monitored packet to a security monitoring system in order to report a packet that might possibly include Botnet to the security monitoring system.

If the anomalous traffic detecting unit 130 generates an anomalous traffic detection signal indicating that anomalous traffic has been generated since an interrupt count value received from the interrupt analyzer 120 is equal to or greater than the reference interrupt count value in the high security mode, the traffic block request unit 140 generates a traffic block request signal without having to receive block approval according to a user input signal through the user matching unit 150, so as to block the transmission packet that has caused the anomalous traffic from being output to the network.

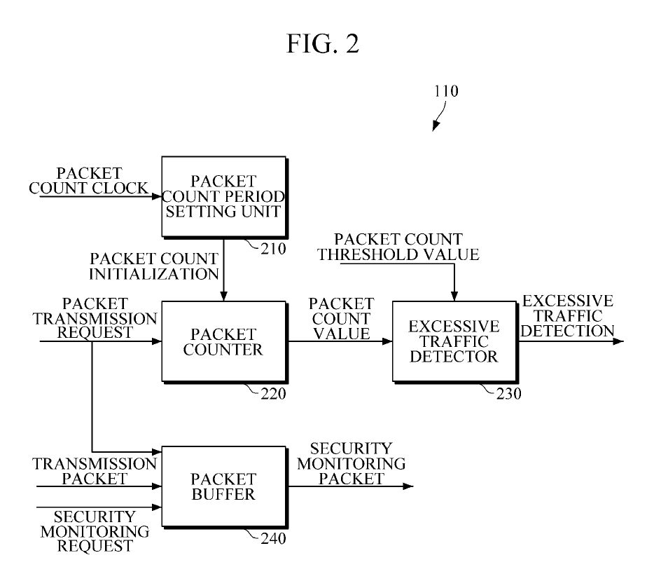

FIG. 2 is a diagram illustrating an example of the packet processor 110 of FIG. 1.

The packet processor 110 counts the number of packets that are transmitted, determines whether the count value of the packets exceeds a predetermined threshold value, determines, if the count value of the packets exceeds the predetermined threshold value, that excessive network is traffic has been generated in the terminal apparatus 100, and requests blockage of network traffic.

The packet processor 110 includes a packet count period setting unit 210, a packet counter 220, an excessive traffic detector 230, and a packet buffer 240.

The packet count period setting unit 210 creates a packet count period and sets the packet count period in the packet counter 220. The packet count period setting unit 210 may be a timer for setting a period for which packets are counted. Also, the packet count period setting unit 210 may receive a packet count clock signal, generate a packet count initializing signal in units of a predetermined packet count period, and transfer the packet count initializing signal to the packet count unit 220 so that the packet count unit 220 can count the number of packets for the packet count period.

The packet count unit 220 may count the number of packets that are transmitted, in units of the packet count period set by the packet count period setting unit 210. Alternatively, the packet count unit 220 may count the number of transmission packets by receiving a packet transmission request signal from a module (not shown) that decides transmission of packets in order to transmit packets in units of the packet count period set by the packet count period setting unit 210. The packet count unit 220 initializes the packet count value if it receives the packet count initializing signal, and then starts counting packets again.

The excessive traffic detector 230 compares the number of packets counted for the packet count period to a predetermined packet count threshold value which is a criterion for determining occurrence of excessive traffic, to detect excessive traffic. That is, the excessive traffic detector 230 compares a packet count value received from the packet counter 220 to a predetermined packet count threshold value, and generates, if the packet count value is greater than the predetermined packet count threshold value, an excessive traffic detection signal.

The packet buffer 240 may receive transmission packets and temporarily store them therein. Particularly, if it receives a security monitoring request from the excessive traffic detector 230 and the traffic block request unit 140 (see FIG. 1), the packet buffer 240 temporarily stores the corresponding packet in order to report it to a security monitoring center (not shown). The packet buffer 240 may buffer a transmission packet which is to be transmitted to the network and, if it receives a security monitoring request signal from the anomalous traffic detector 230, change the transmission packet to a security monitored packet, and then transmit the security monitored packet to the security monitoring center.

By transmitting such a security monitored packet to the security monitoring center to cause the security monitoring center to analyze the security monitored packet, it is possible to extend a time required for malicious code such as Botnet infects neighboring systems through self-replication. Also, if the packet buffer 240 receives a traffic block request signal from the traffic block request unit 140, the packet buffer 240 may delete the corresponding transmission packet that generated anomalous traffic due to which the traffic block request signal was generated, thereby preventing the anomalous traffic from being output to the network.

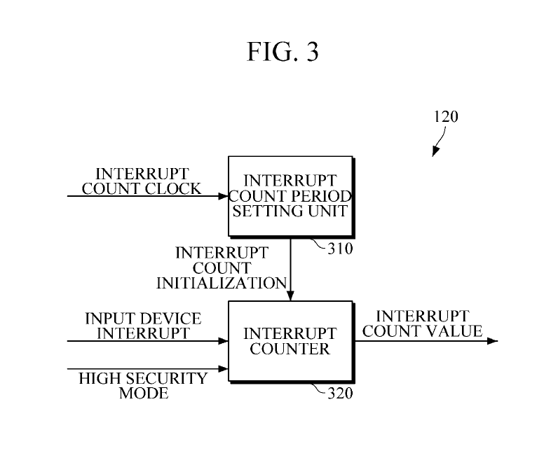

FIG. 3 is a diagram illustrating an example of the interrupt analyzer 120 of FIG. 1.

Referring to FIG. 3, the interrupt analyzer 120 includes an interrupt count period setting unit 310 and an interrupt counter 320.

The interrupt count period setting unit 310 creates an interrupt count period for counting interrupts. The interrupt counter 320 counts the number of generated interrupts in units of the interrupt count period set by the interrupt count period setting unit 310.

The interrupt count period setting unit 310 may create an interrupt count period by receiving an interrupt count clock signal. The interrupt count period setting unit 310 may generate an interrupt count initializing signal for initializing the interrupt count unit 310 whenever the interrupt count period elapses, and transfer the interrupt count initializing signal to is the interrupt counter 320.

The interrupt count period setting unit 310 may be implemented as a timer. The interrupt counter 320 counts the number of first interrupts that are generated by transmission packets, and the number of second interrupts that are generated by user inputs, thereby generating an interrupt count value. The interrupt counter 320 is used to determine whether excessive traffic was caused by a user. The interrupt count unit 320 may add the number of the first interrupts to the number of the second interrupts, generate the result of the addition as the interrupt count value, and then transfer the interrupt count value to the anomalous traffic detecting unit 130 (see FIG. 1). However, the interrupt counter 320 may cause deterioration in performance of the processor since the interrupt counter 320 performs counting whenever an interrupt has been generated. Accordingly, the interrupt counter 320 may be configured to operate according to a security mode level. For example, the interrupt counter 320 may be configured to operate only when it receives a “high security mode” signal from the anomalous traffic detecting unit 130.

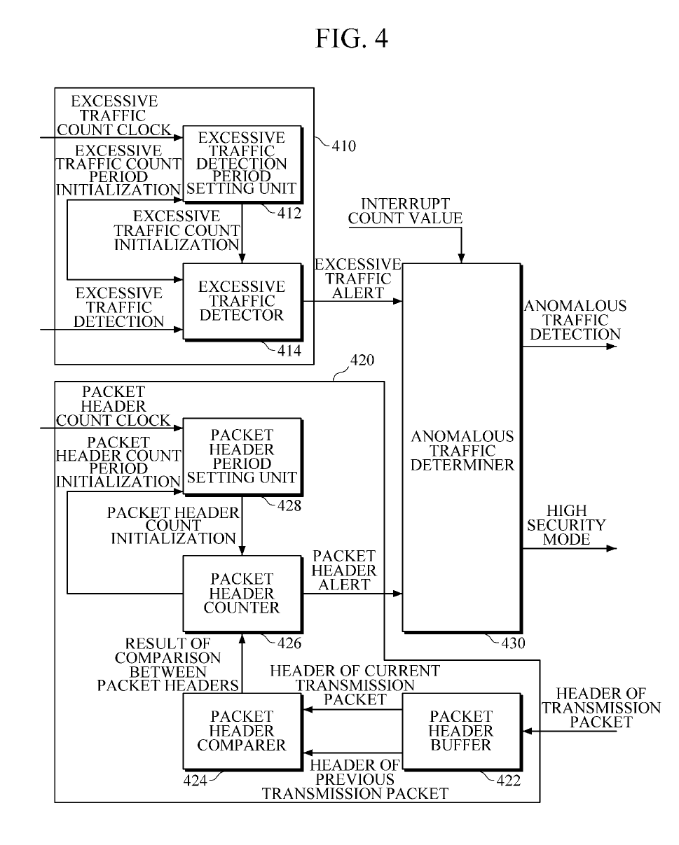

FIG. 4 is a diagram illustrating an example of the anomalous traffic detecting unit 130 of FIG. 1.

The anomalous traffic detecting unit 130 may detect anomalous traffic based on the first condition of excessive traffic being maintained for the first time period and the second condition of the generation count of the same kind of transmission packets exceeding the threshold value for the second time period. The anomalous traffic detecting unit 130 may generate an anomalous traffic detection signal indicating that anomalous traffic has been generated if at least one of the first and second conditions is satisfied.

The anomalous traffic detecting unit 130 may include an excessive traffic determiner 410 for determining whether the first condition is satisfied, an anomalous packet detector 420 for determining whether the second condition is satisfied, and an anomalous traffic determiner 430 that operates according to the processing results of the excessive traffic determiner 410 and the anomalous packet detector 420.

The excessive traffic determiner 410 may include an excessive traffic detection period setting unit 412 and an excessive traffic detector 414.

The excessive traffic detection period setting unit 412 counts received excessive traffic count clock signals, and generates an excessive traffic count initializing signal for initializing a counter of the excessive traffic detector 414 in units of a predetermined excessive traffic detection period.

The excessive traffic detector 414 determines whether an excessive traffic detection signal received from the packet processor 120 (see FIG. 1) is maintained for the predetermined excessive traffic detection period to thereby determine whether excessive traffic has been generated in the terminal apparatus 100.

If an excessive traffic detection signal received from the packet processor 120 is maintained for the predetermined excessive traffic detection period, the excessive traffic detector 414 may generate an excessive traffic alert signal and transfer the excessive traffic alert signal to the anomalous traffic determiner 430.

Also, if an excessive traffic count initializing signal is received from the excessive traffic detection period setting unit 412, the excessive traffic detector 414 initializes its internal counter. The excessive traffic detector 414 generates an excessive traffic count period initializing signal if the “excessive traffic detected” state is released before the excessive traffic detection period elapses, and initializes the previous count value, thereby minimizing deterioration in performance of the terminal due to the excessive traffic generated momentarily.

The anomalous packet detector 420 may include a packet header buffer 422, a packet header comparer 424, a packet header counter 426, and a packet header period setting unit 428.

The packet header buffer 422 receives headers of transmission packets, and transfers the header of a current transmission packet and the header of the previous transmission packet to the packet header comparer 424.

The packet header comparer 424 compares the header of the current transmission packet to the header of the previous transmission packet, and transfers the result of the comparison to the packet header counter 426.

The packet header counter 426 counts packets having the same header for a predetermined packet header period set in the packet header period setting unit 428, and generates a packet header alert signal if the count value exceeds a threshold value set in the packet header counter 426, and transfers the packet header alert signal to the anomalous traffic determiner 430.

If the count value does not exceed the threshold value for the predetermined packet header period set in the packet header period setting unit 428, the packet header counter 426 transfers a packet header count period initializing signal to the packet header period setting unit 460 and initializes the packet header period.

As such, according to the configuration of the packet header buffer 422, the packet header comparer 424, the packet header counter 426, and the packet header period setting unit 428, by comparing the header of a current transmission packet to the header of the previous transmission packet based on header information of transmission packets, it is possible to determine whether a large amount of the same kind of transmission packets is transmitted in a short time.

If at least one of the first condition of excessive traffic being maintained for the first time period and the second condition of the generation count of the same kind of transmission packets exceeding the threshold value for the second time period is satisfied, the anomalous traffic determiner 430 determines that anomalous traffic has been generated, and generates an anomalous traffic detection signal.

The anomalous traffic determiner 430 may operate differently in a high security mode and a normal security mode. If the anomalous traffic determiner 430 receives an excessive traffic alert signal and a packet header alert signal, the anomalous traffic determiner 430 may generate a high security mode signal and transfer the high security mode signal to the interrupt analyzer 120 (see FIG. 1).

If the anomalous traffic determiner 430 receives an excessive traffic alert signal or a packet header alert signal in the normal security mode, the anomalous traffic determiner 430 may generate an anomalous traffic detection signal. In the high security mode, if an interrupt count value received from the interrupt analyzer 120 exceeds a predetermined threshold value, the anomalous traffic determiner 430 generates an anomalous traffic detection signal to thus request blockage of network traffic in order to prevent excessive traffic generated in the terminal from influencing the network.

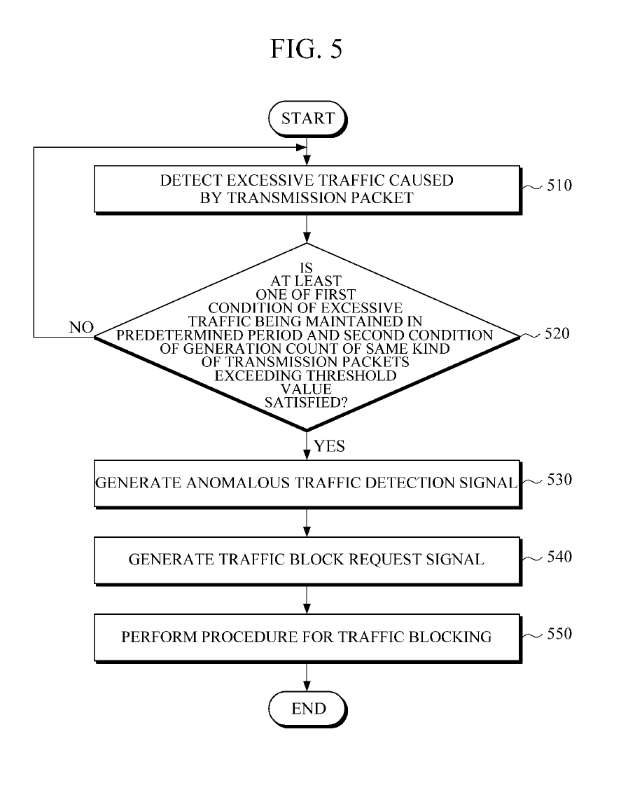

FIG. 5 is a flowchart illustrating an example of a method of preventing cyber-attack based on a terminal.

Referring to FIGS. 1 and 5, the terminal apparatus 100 detects excessive traffic caused by a transmission packet (510).

The terminal apparatus 100 determines whether at least one of a first condition of the excessive traffic being maintained for a predetermined excessive traffic detection period (or a first time period) and a second condition of the generation count of the same kind of transmission is packets exceeding a threshold value for a packet header period (or a second time period) is satisfied (520).

If at least one of the first and second conditions is satisfied, the terminal apparatus 100 generates an anomalous traffic detection signal (530).

If the anomalous traffic detection signal is generated, the terminal apparatus 100 generates a traffic block request signal for requesting blockage of the transmission packet (540). According to the traffic block request signal, the terminal apparatus 100 may prevent the transmission packet that generated the excessive traffic from being output from the terminal apparatus 100 to a network (550). Also, if the traffic block request signal is generated, the terminal apparatus 100 transmits the transmission packet that generated the excessive traffic to a security monitoring center to request the security monitoring center to determine whether the transmission packet includes an attack pattern. Alternatively, if the traffic block request signal is generated, the terminal apparatus 100 may receive approval from a user to prevent the transmission packet from being output to the network.

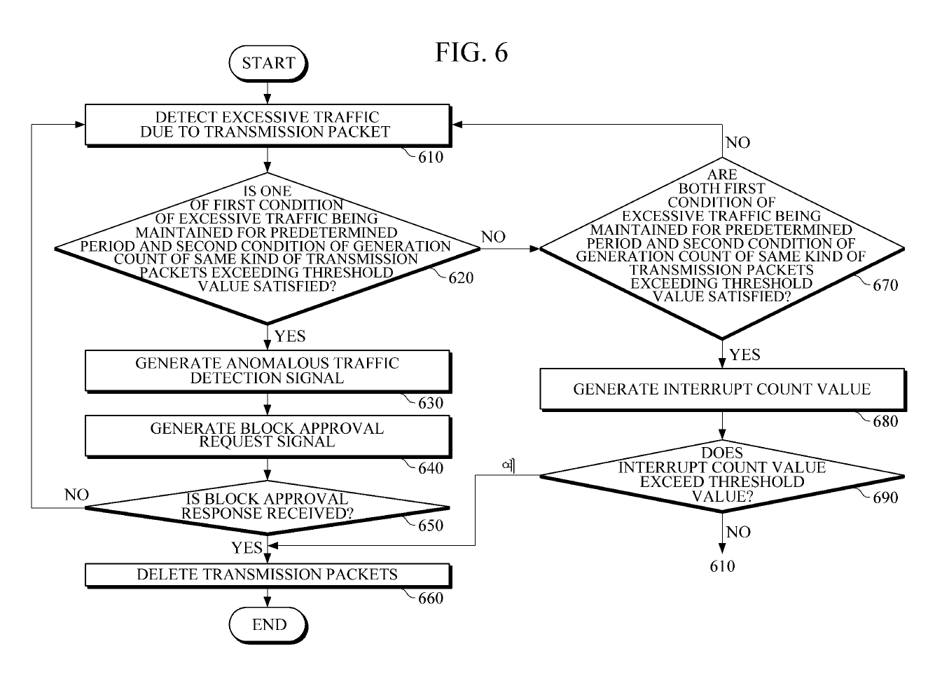

FIG. 6 is a flowchart illustrating another example of a method of preventing cyber-attack based on a terminal.

Referring to FIGS. 1, 5 and 6, the terminal apparatus 100 detects excessive traffic caused by a transmission packet (610). Then, the terminal apparatus 100 determines whether one of the first and second conditions is satisfied (620). If at least one of the first and second conditions is satisfied, the terminal apparatus 100 determines that anomalous traffic has been generated, and generates an anomalous traffic detection signal (630). Then, the terminal apparatus 100 may generate a block approval request signal for asking for a user's approval to block the corresponding packet (640). If a block approval response for approving traffic blocking is received from the user (650), the terminal apparatus 100 deletes transmission packets is buffered in an internal storage unit, which can cause excessive traffic, thereby preventing the transmission packets from being output to a network (660). Also, the terminal apparatus 100 transmits the corresponding transmission packet to a security monitoring center to request the security monitoring center to determine whether the transmission packet includes an attack pattern.

Meanwhile, when both the first and second conditions are satisfied (670), the terminal apparatus 100 enters a high security mode requiring a high level of security, and counts the number of interrupts and generates an interrupt count value (680). That is, the terminal apparatus 100 counts the number of first interrupts generated in units of a predetermined time period by transmission packets, and the number of second interrupts generated by user inputs, and generates an interrupt count value. Then, the terminal apparatus 100 determines whether the interrupt count value is equal to or greater than a reference interrupt count value (690). If the interrupt count value is equal to or greater than a reference interrupt count value, the terminal apparatus 100 generates an anomalous traffic detection signal indicating that anomalous traffic has been generated, and deletes transmission packets stored in the internal storage unit, which can cause excessive traffic, thereby preventing the transmission packets from being output to the network (660). As such, in the high security mode, if an anomalous traffic detection signal is generated, the transmission packet is prevented from being transmitted without having to receive the user's approval.

Therefore, according to the examples described above, by preventing a large amount of traffic generated in a terminal from entering a network in advance before any attack pattern is detected, DDos attack using malicious code can be blocked in advance, thereby minimizing social confusion and economic loss, compared to a conventional security method based on a centralized monitoring system.

The present invention can be implemented as computer-readable code in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as used in Internet transmission. In addition, the computer-readable recording medium may be distributed to computer systems over a network, in which computer-readable code may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A terminal apparatus comprising:
a packet processor configured to determine whether excessive traffic is generated by a transmission packet;
an anomalous traffic detecting unit configured to determine whether anomalous traffic is generated, using a first condition of the excessive traffic being maintained for a first time period and a second condition of a generation count of the same kind of transmission packets exceeding a predetermined threshold value for a second time period; and
a traffic block request unit configured to generate a traffic block request signal for requesting blockage of the transmission packet according to the result of determining whether anomalous traffic is generated.

2. The terminal apparatus of claim 1, wherein when at least one of the first and second is conditions is satisfied, the anomalous traffic detecting unit generates an anomalous traffic detection signal indicating that anomalous traffic has been generated.

3. The terminal apparatus of claim 2, further comprising a user matching unit configured to determine whether to block traffic based on a user input signal,
wherein the packet processor blocks transmission of the transmission packet when a block approval response signal for approving traffic blocking is received from the user matching unit based on the user input signal.

4. The terminal apparatus of claim 3, wherein the user matching unit processes a transmission packet that generated the anomalous traffic, and provides a user interface screen for providing detailed information about the transmission packet.

5. The terminal apparatus of claim 1, further comprising an interrupt analyzer configured to count a number of first interrupts generated by transmission packets for a predetermined interrupt count period, and a number of second interrupts generated by a user's inputs for the predetermined interrupt count period, thereby generating an interrupt count value,
wherein the anomalous traffic detecting unit controls the interrupt analyzer to operate when both the first and second conditions are satisfied.

6. The terminal apparatus of claim 5, wherein the interrupt analyzer adds the number of the first interrupts to the number of the second interrupts, and generates the result of the addition as the interrupt count value.

7. The terminal apparatus of claim 5, wherein the anomalous traffic detecting unit receives the interrupt count value, and generates, when the interrupt count value is equal to or greater than a reference interrupt count value, an anomalous traffic detection signal indicating that anomalous traffic has been generated.

8. The terminal apparatus of claim 5, wherein when the predetermined interrupt count period elapses, the interrupt analyzer initializes the interrupt count value, and generates an interrupt count value for the next interrupt count period.

9. The terminal apparatus of claim 1, wherein the packet processor receives the traffic block request signal, and transmits a transmission packet related to the traffic block request signal to a security monitoring center connected through a network in order to determine whether the transmission packet includes an attack pattern.

10. The terminal apparatus of claim 1, wherein when it receives the traffic block request signal in a normal security mode, the packet processor blocks transmission of the transmission packet after receiving approval from a user, and when it receives the traffic block request signal in a high security mode requiring a higher level of security than the normal security mode, the packet processor blocks transmission of the transmission packet without having to receive approval from the user.

11. The terminal apparatus of claim 1, wherein the packet processor comprises:
a packet counter configured to count a number of transmission packets in a predetermined packet count period;
a packet count period setting unit configured to create the predetermined packet count period;
a packet buffer configured to buffer transmission packets, and transmit a transmission packet which is expected to include an attack pattern to a security monitoring system; and
an excessive traffic detector configured to generate an excessive traffic detection signal when the counted number of transmission packets exceeds a predetermined threshold value.

12. The terminal apparatus of claim 11, wherein the packet count period setting unit generates a packet count initializing signal in units of the predetermined packet count period, and initializes the counted number of transmission packets when the packet count initializing signal is received.

13. The terminal apparatus of claim 1, wherein the anomalous traffic detecting unit comprises:
an excessive traffic determiner configured to determine whether the excessive traffic is maintained for the first time period; and
an anomalous packet detector configured to determine whether the generation count of the same kind of transmission packets exceeds the predetermined threshold value for the second time period.

14. A method of preventing cyber-attack in a terminal apparatus, comprising:
determining whether excessive traffic is generated by a transmission packet;
determining whether anomalous traffic is generated using a first condition of the is excessive traffic being maintained for a first time period and a second condition of a generation count of the same kind of transmission packets exceeding a predetermined threshold value for a second time period; and
generating a traffic block request signal for requesting blockage of the transmission packet according to the result of determining whether anomalous traffic is generated.

15. The method of claim 14, wherein when at least one of the first and second conditions is satisfied, it is determined that anomalous traffic has been generated.

16. The method of claim 14, further comprising receiving the traffic block request signal, and transmitting the transmission packet to a security monitoring center in order to determine whether the transmission packet includes an attack pattern.

17. The method of claim 14, further comprising:
receiving, when one of the first and second conditions is satisfied, a user input signal of deciding whether to perform traffic blocking with respect to the transmission packet according to the traffic block request signal, and performing traffic blocking according to the user input signal.

18. The method of claim 17, further comprising:
counting, when both of the first and second conditions are satisfied, a number of first interrupts generated by transmission packets for a predetermined interrupt count period, and a number of second interrupts generated by a user's inputs for the predetermined interrupt count period, thereby generating an interrupt count value; and
generating, when the interrupt count value is equal to or greater than a reference interrupt count value, an anomalous traffic detection signal indicating that anomalous traffic has been generated; and
deleting, when the anomalous traffic detection signal is generated, a transmission packet related to the anomalous traffic detection signal to block the anomalous traffic.

19. The method of claim 14, wherein when the traffic block request signal is received in a normal security mode, transmission of the transmission packet is blocked after approval from a user is received, and when the traffic block request signal is received in a high security mode requiring a higher level of security than the normal security mode, transmission of the transmission packet is blocked without having to receive approval from the user.
